(19) United States
(12) Patent Application Publication
(10) Pub. No.: US 2003/0110687 A1
(43) Pub. Date: Jun. 19, 2003

(54) Method of producing plantlet of C4 plant

(76) Inventors: Toyoki Kozai, Matsudo-shi (JP); Yulan Xiao, Matsudo-shi (JP); Osamu Hasegawa, Tokyo (JP); Yojiro Ohno, Okazaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/255,466

(22) Filed: Sep. 26, 2002

(30) Foreign Application Priority Data
Sep. 27, 2001 (JP) 2001-297267

(51) Int. Cl. A01B 79/02

(52) U.S. Cl. 47/58.1 LS

(57) ABSTRACT

A method of producing a plantlet of a C₄ plant, includes transplanting a tissue of the C₄ plant into a culture medium free of sugar and containing a porous supporting material; and culturing the tissue while supplying carbon dioxide under irradiation of light to form a plantlet of the plant. The method has improved practical aspects such as cost and cultivation period.

### BACKGROUND OF THE INVENTION

1. Field of the Invention

The present invention relates to a production method of photoautotrophic culture of a plantlet of a C₄ plant, in particular sugarcane (photoautotrophic micropropagation).

2. Description of the Related Art

Sugarcane is a plant cultivated worldwide mainly for the production of sugar, its acreage reaching to 20 million ha in the world, and is very important from economical and industrial viewpoints (FAO Production Yearbook 51:155, 1997).

It has conventionally been common practice to propagate sugarcane vegetatively. That is, propagation is performed by obtaining a plurality of shoots from a stem cutting or seedpiece as propagule of about 20 to 30 cm long, cutting them to individual shoots, and obtaining stem cuttings again from the grown shoots. Eventually, the stem cuttings are transplanted in the fields to produce sugarcane. Thus, a large number of stem cuttings are required every year for propagation as well as for planting, especially when a new variety of sugarcane is released to the market. However, this production method takes a long time. For example, it takes about 2 months as an acclimatization period only. Therefore, the fact is that the method cannot be said to be a fully satisfactory production method, and there has been an ongoing demand for a more efficient, more economical propagation and production system.

On the other hand, micropropagation by plant tissue culture is known as another useful vegetative propagation method. This is a method capable of producing a large number of virus- or pathogen-free and genetically superior homogeneous transplants. Therefore, a significant increase in yield of sugar is expectable if this technique is applied to sugarcane production. However, conventionally, the method has some problems since it is practiced under the condition where sugar is added to a culture medium as a carbon source, known as “condition of photomixotrophic culture” or “condition of heterotrophic culture”, resulting not being commercialized with sugarcane, yet. The problems include (1) slow growth of plantlets, (2) poor shoot and root developments, (3) loss of plantlets due to biological contamination, (4) low percentage of survival during the acclimatization, etc (Desjardings, et. al., Carbon nutrient in vitro regulation and manipulation of carbon assimilation in micropropagation system: Automation and Environmental Control in Plant Tissue Culture, Kluwer Academic Publishers, p441-465, 1995).

Recent research revealed that chlorophyllous explants from a C₃ plant can be grown on sugar-free media, i.e., photoautotrophically. It also indicated that many of the above-mentioned problems can be solved providing the use of technique of controlling the in vitro environment favorably for promoting photosynthesis and the explants grow better on sugar-free medium than on sugar-containing medium (Kozai, Micropropagation under photoautotrophic conditions: Micropropagation Technology and Application, Kluwer Academic Publishers, p447-469, 1991). The phrase “controlling the in vitro environment” as used herein refers to increasing the CO₂ concentration or/and light intensity in a culture environment to a level higher than the condition used in a conventional photomixotrophic culture. Also, it has been indicated that since photoautotrophic micropropagation has also been an effective method for many species of C₃ plants to increase rooting percentage, and to produce physiologically and morphologically high quality plantlets, the method provides a technique for the reduction of production costs of plantlets even if taking complexity of environmental control into consideration (Aitken-Christie, et. al., Automation in plant tissue culture. General introduction and overview: Automation and Environmental Control in Plant Tissue Culture, Kluwer Academic Publishers, p-18, 1995).

However, the researches represented by the above examples have been made all on C₃ plants but no description has been made on C₄ plants. C₄ plants such as sugarcane and corn are known to have a unique photosynthesis pathway (C₄ photosynthesis pathway) that differs from that of C₃ plants. It is known that the C₄ plants have a CO₂ compensation point (<10 μmol/mol), which is lower than that of the C₃ plants, and a CO₂ saturation point (<1,000 μmol/mol) which is lower than that of the C₃ plants (Salisbury and Ross, Plant Physiology, Wadsworth Publishing Company, p257-260, 1998). It is also known that the C₄ plants have a light compensation point (PPF (photosynthesis-effective photon flux)>20 μmol/m²/s), which is higher than that of the C₃ plants, and a light saturation point (PPF>1,000 μmol/m²/s), which is higher than that of the C₃ plants (Hesketh, Limitations to photosynthesis responsible for differences among species, Crop Sci., 3: p493, 1963). Therefore, it is considered that the action and effect of photoautotrophic culture (photoautotrophic micropropagation) on the C₃ plants may be different from the action and effect of photoautotrophic culture (photoautotrophic micropropagation) on the C₄ plants. However, none of the above-mentioned researches has clarified photoautotrophic micropropagation of the C₄ plants.

In 1991, Walker et al. studied suitable conditions for the propagation of sugarcane, one of the C₄ plants, by culture but failed to find the superiority of photoautotrophic micropropagation and concluded that photomixotrophic micropropagation with sugar, and without CO₂ enrichment and ventilation was most excellent (Walker, et. al., Optimal environment for sugarcane micropropagation, Trans. of the ASAE, 34(6): p2609-2614, 1991).

Also, Tay et al. reported on the influence of CO₂ concentration on the culture of sugarcane (Tray, et. al., Effect of varying CO₂ and light levels on growth of Hedyotis and sugarcane shoot cultures, In vitro Cell. Dev. Biol. Plant, 36: p118-124, 2000). However, the condition studied was with sugar and they concluded that a difference in growth of sugarcane due to a difference in CO₂ concentration is minimal, with referring to the fact that the C₄ pathway in the C₄ plants is low in sensitivity to the external CO₂ environment. This clearly indicates that they had no idea at all on photoautotrophic micropropagation.

On the other hand, in 2000, Erturk and Walker found that sugarcane can grow photoautotrophically under the conditions of a light intensity of 180 μmol/m²/s and a CO₂ concentration of 2,200 μmol/mol (Erturk and Walker, Effect of light, carbon dioxide, and hormone levels on transformation to photoautotrophy of sugarcane shoots in micropropagation, Trans. Of the ASAE, 43(1): p147-151, 2000). However, the results they showed only indicated the possibility of photoautotrophic micropropagation and from the growth results it cannot be said that the technique of concern has been developed to a level where it is practically usable. So far as their report is read, there still remained many problems to be solved., for example, (1) plant growth regulator (plant hormone), which is a factor incurring extra process and cost and which is a cause of variation to plants, could not be eliminated, (2) no consideration was made on ventilation condition in the culture environment, (3) use of a gelling agent similar to that used in the conventional method as a supporting material for the plant resulted in that the obtained roots shaped like underwater roots and they did not normally function when they were transplanted to the soil, and so on.

### SUMMARY OF THE INVENTION

Under the circumstances described above, the present invention has been made and an object of the present invention is to provide a production method of the photoautotrophic micropropagation of a plantlet of a C4 plant, in particular sugarcane, in which a tissue of the C4 plant is cultured by transferring it in a porous/fibrous medium containing no sugar and no plant growth regulator, and which is improved in cost, culture period, etc.

The inventors of the present invention has made extensive studies with a view to solving the above-mentioned problems and as a result they have found that transplanting a tissue of a C₄ plant to a medium that contains neither sugar nor plant growth regulator but contains a porous supporting material and culturing it under light irradiation with supplying carbon dioxide can promote rooting and growth of plantlets of a C₄ plant, in particular sugarcane, extremely well. Also, they have found that culture by setting the light irradiation condition to a high PPF level, maintaining the concentration of carbon dioxide at a high concentration, and controlling the ventilation condition in the above-mentioned culture can promote the growth of the plantlet.

That is, the present invention provides the following:

(1) A method of producing a plantlet of a C₄ plant, comprising:

transplanting a tissue of the C₄ plant into a culture medium free of sugar and containing a porous supporting material; and

culturing the tissue while supplying carbon dioxide under irradiation of light to form a plantlet of the plant.

(2) A method according to item (1), wherein the tissue of the C₄ plant is cultured in a culture vessel that allows passage of carbon dioxide to an outside of the vessel.

(3) A method according to item (2), wherein the culture vessel allows ventilation to the outside and wherein the concentration of carbon dioxide in the inside of the culture vessel is controlled by such way that the concentration of carbon dioxide is maintained higher in atmosphere around the culture vessel than in the inside of the culture vessel.

(4) A method according to item (3), wherein the tissue of the C₄ plant is cultured while ventilation is performed at a number of air exchanges or 2 to 20/h.

(5) A method according to item (3), wherein the tissue of the C₄ plant is cultured at a concentration of carbon dioxide in the atmosphere around the culture vessel of 1,000 to 2,000 μmol/mol.

(6) A method according to item (3), wherein the tissue of the C₄ plant is cultured at a concentration of carbon dioxide in the inside of the culture vessel of 400 to 2,000 μmol/mol.

(7) A method according to item (5), wherein the tissue of the C₄ plant is cultured at a concentration of carbon dioxide in the inside of the culture vessel of 400 to 2,000 μmol/mol.

(8) A method according to item (2), wherein the culture vessel is provided with means for intaking and venting air to supply carbon dioxide into the vessel.

(9) A method according to item (8), wherein the tissue of the C₄ plant is cultured with ventilation through the means for intaking and venting air at a number of air exchanges of 2 to 20/h.

(10) A method according to item (8), wherein the tissue of the C₄ plant is cultured at a concentration of carbon dioxide in the atmosphere around the culture vessel of 1,000 to 2,000 μmol/mol.

(11) A method according to item (8), wherein the tissue of the C₄ plant is cultured at a concentration of carbon dioxide in the inside of the culture vessel of 400 to 2,000 μmol/mol.

(12) A method according to item (10), wherein the tissue of the C₄ plant is cultured at a concentration of carbon dioxide in the inside of the culture vessel of 400 to 2,000 μmol/mol.

(13) A method according to item (1), wherein the tissue of the C₄ plant is cultured under light irradiation at a photosynthetic photon flux of 100 to 500 μmol/m²/s.

(14) A method according to item (1), wherein the porous supporting material is at least one member selected from the group consisting of vermiculite, pearlite, cellulose fiber, cellulose derivative fiber, polyester fiber, ceramic fiber, rock wool, and mixtures thereof.

(15) A method according to item (14), wherein the porous supporting material comprises a mixture of cellulose fiber and vermiculite.

(16) A method according to item (1), wherein the medium comprises a culture solution free of plant growth regulators.

(17) A method according to item (1), wherein the C₄ plant is sugarcane.

### BRIEF DESCRIPTION OF THE DRAWINGS

FIG. 1(a) is a photograph of photoautotrophically grown sugarcane plantlets on day 10;

FIG. 1(b) is a photograph of photoautotrophically grown sugarcane plantlets on day 18;

FIG. 2 is a graph illustrating changes in CO₂ concentration with lapse of time in a culture vessel and in a culture room, respectively; and

FIG. 3 is a graph illustrating net photosynthesis rates of sugarcane plantlets with lapse of time in each test lot.

### DETAILED DESCRIPTION OF THE PREFERRED EMBODIMENTS

Hereinafter, the present invention will be described in detail.

The production method of a plantlet of a C₄ plant according to the present invention is a method for the production of a C₄ plant by a photoautotrophic micropropagation method in which a tissue of the C₄ plant is transplanted to a medium free of sugar and cultured therein, characterized in that the culture of the C₄ plant is performed by using a porous supporting material as the above-mentioned medium under light irradiation with supplying carbon dioxide.

Here, the plants to which the present invention can be applied are not particularly limited so far as they are C₄ plants and include, for example, those plants that belong to the families, Gramineae, Cyperaceae, Chenopodiaceae, Euphorbiaceae, Compositae, and Amaranthaceae, and in particular, sugarcane and corn. Particularly, for sugarcane, the production method of the present invention can be used advantageously. Generally, sugarcane is a generic name given to plants belonging to the genus Saccharum that accumulate sucrose.

As the material tissue (explant) of a plant used for culture can be used stem cuttings, seedlings and the like. They have conventionally one or more leaves.

In the culture method of the present invention, it is recommended to set the PPP photosynthetic photon flux) value of the light to be irradiated at high levels. A specific value is in the range of 100 to 500 μmol/m²/s, preferably 200 to 500 μmol/m²/s and more preferably 200 to 450 μmol/m²/s.

Generally, as the light to be irradiated, for example, one from a white fluorescent lamp may be used.

Also, in the culture method of the present invention, the CO₂ concentration is controlled during the culture period so that the culture of plantlets can be performed under a high CO₂ concentration atmosphere.

Means for making the atmosphere around the plantlets have a high CO₂ concentration specifically includes the following modes.

One mode is to use a culture vessel that allows ventilation to the outside and culture the C₄ plant in the culture vessel with maintaining the CO₂ concentration in the atmosphere around the culture vessel at a high concentration. By increasing the CO₂ concentration around the culture vessel, the CO₂ concentration in the culture vessel can be increased. For example, when the culture vessel is placed in a culture room and cultivation is carried out in the culture room, it is advantageous that cultivation is performed by setting the CO₂ concentration in the culture room to 1,000 to 2,000 μmol/mol, preferably 1,000 to 1,800 μmol/mol and more preferably 1,000 to 1,700 μmol/mol.

On this occasion, the culture vessel that allows ventilation to the outside specifically includes a culture vessel whose lid and/or wall is provided with a gas permeable film on a part thereof. As the gas permeable film, for example, Milli-Seal (Millipore Corporation) can be suitably used.

Another mode is to use a culture vessel, in which the C₄ plant is cultivated with positively providing means for intaking and venting air, such as an air pump that can forcibly perform air intake and vent, and supply air having a high CO₂ concentration to the culture vessel. For example, by using the method described in Heo, J. and Kozai, T., 1999, Forced ventilation micropropagation system for enhancing photosynthesis, growth and development of sweetpotato plantlets. Environment Control in Biology. 37(1):93-92, air having a high CO₂ concentration can be abundantly fed to the culture vessel so that the ventilation of the culture vessel can be enhanced.

N number of air exchanges per hour of the culture vessel may be advantageously measured by the method described in Kozai, T. et al., 1986, Fundamental studies on environments in plant tissue culture vessels (2), Effects of stoppers and vessels on gas exchange rates between inside and outside of vessels closed with stoppers. J. Agr. Met. 42 (hereinafter, also referred to “Kozai et al. (1986)”. In that method, the number of air exchanges may be 2 to 20/h, preferably 3 to 20/h.

It is preferred that the number of air exchanges is controlled so as to assume a small value among values in the above-mentioned range in several days in the initial stage of culture, and then gradually increase to a larger value.

It is recommendable to perform the culture by setting the CO₂ concentration in the culture vessel to a value in the range of 400 to 2,000 μmol/m²/s, preferably 400 to 1,800 μmol/m²/s, and more preferably 500 to 1,600 μmol/m²/s.

Since the CO₂ concentration in the culture vessel is also influenced by the photosynthesis rate of the plantlets in the culture vessel, it is recommendable that the CO₂ concentration around the above-mentioned culture vessel and the number of air exchanges may be varied as appropriate so that the CO₂ concentration in the culture vessel can be maintained in a preferred range during the cultivation period.

Next, the culture medium used in the present invention will be described.

In the present invention, a culture medium containing no sugar (free of sugar) is used. The culture medium is not particularly limited so far as it does not harm the effect of the present invention. It includes, for example, an MS culture medium modified with doubled strength of KH₂PO₄, MgSO₄, and Na₂-EDTA.

Also, it is unnecessary to add plant growth regulators such as auxins and cytokinins to the culture medium used in the present invention.

Furthermore, in the present invention, a pours supporting material is used. The porous supporting material is not particularly limited so tar as it does not harm the effect of the present invention. It is recommendable to form it from, for example, vermiculite, pearlite, cellulose fiber, cellulose derivative fiber, polyester fiber, ceramic fiber, rock wool, and mixtures of these. It is particularly preferred that a mixture of vermiculite and cellulose fiber (for example, Florialite (manufactured by Nisshinbo Industries, Inc.)) is used.

For other culture conditions, the temperature is preferably 25 to 30° C. and the humidity in the culture vessel is 60 to 100%. It is preferred that the humidity is controlled so as to be set to a high level in the initial stage of the cultivation and then gradually decrease.

It is preferred that the culture vessel is at least partly light permeable to make a plantlet photosynthesize. For example, a culture vessel having a transparent lid can be used.

In the present invention, during the period of culture of plantlets, it is recommendable that the culture is performed under the light condition of conventionally 12 to 16 hours/day light period and 12 to 8 hours/day dark period.

The obtained plantlets are transplanted to the fields usually after they are acclimatized under ex vitro environment. It is also possible to transplant the plantlets of a C₄ plant obtained by the in vitro culture by using the production method of the present invention to the fields by eliminating the acclimatization process under ex vitro environment.

The following effects can be expected by the present invention.

That is, since the growth of C₄ plants by photoautotrophic culture using a porous supporting material under controlled environment enables production of healthy seedlings in a short time with good efficiency, not only it is expectable to simplify the stage of acclimatization but also it is expectable to eliminate the process of acclimatization and transplant the plantlets directly to the fields.

Furthermore, when shoots are transferred to the acclimatization environment or directly transplanted to the fields, transplanting the plantlets together with the supporting material enables to minimize the operation of washing the root and avoids the damages to the root, so that high survival percentage and growth rate of the plantlets can be expected.

As described above, the production method of photoautotrophic micropropagation of a plantlet of C₄ plants according to the present invention can provide a production method of a plantlet of C₄ plants in which practical aspects such as cost and culture period are improved.

Hereinafter, the present invention will be described in more detail by way of examples. However, the present invention should not be considered as being limited to the examples.

<1> Materials and Methods

Single shoots of photomixotrophically grown sugarcane (Code number: Roc22) plantlets were used as explants in which average leaf area, fresh and dry weights per explant were 210 mm², 153 mg and 13 mg, respectively.

The single shoots were transplanted in Magenta type culture vessels (370 ml in volume, 9.7 cm high; manufactured by Verde Co., Ltd., Japan), each vessel containing two explants and 60 ml of MS solution modified with doubled strength of KH₂PO₄, MgSO₄, and Na₂-EDTA.

The pH of the medium was adjusted to 5.8 before antoclaving. Throughout the culture period, the air temperature and relative humidity in the culture room were kept at 27 to 28° C. and 70 to 75%, respectively. The light condition was 16 h/day supplied with white fluorescent lamps.

The above-mentioned experiment had seven treatments. Treatment codes and description of the respective treatments are given in Table 1 described below. For photoautotrophic micropropagation treatments, a factorial experiment was designed with 2 levels of PPF (photosynthetic photon flux) and three levels of N (the number of air exchanges of the culture vessel) and with 10 replications per treatment. The results were compared with those in the control treatment,(conventional, photomixotrophic cultivation using sugar-containing agar medium under low PPF and low N conditions). Analysis of variance (ANOVA, here, six types of analysis resulting from combination of two levels of PPF and three levels of N) and Duncan's multiple range test were conducted.

TABLE 1

| | | | | Number of air | | |
|---|---|---|---|---|---|---|
| | PPF (μmol/m²/s) | | | exchanges( /h) | | |
| | 0-3 | 4-10 | 11-18 | 0-3 | 4-10 | 11-18 |
| Treatment | days | days | days | days | days | days |
| Control | 60 | 60 | 60 | 0.2 | 0.2 | 0.2 |
| LL* | 100 | 200 | 300 | 1.8 | 1.8 | 1.8 |
| LM | 100 | 200 | 300 | 1.8 | 2.7 | 3.6 |
| LH | 100 | 200 | 300 | 2.7 | 6.0 | 10.2 |
| HL | 200 | 300 | 400 | 1.8 | 1.8 | 1.8 |
| HM | 200 | 300 | 400 | 1.8 | 2.7 | 3.6 |
| HH | 200 | 300 | 400 | 2.7 | 6.0 | 10.2 |

Here, in Table 1, the first (left side) letter attached with the symbol “*”, “L” and “H”, denote “low” and “high” PPF, respectively. The second (right side) letter “L”, “M” and “H” denote “low”, “medium” and “high” number of air exchanges of the culture vessel, respectively. In all the treatments except the control treatment, the medium contains no sugar.

<1-1> Photoautotrophic culture (photoautotrophic micropropagation) Under photoautotrophic culture conditions, the above-mentioned sugarcane explants were cultured in vitro on the Florialite described hereinbelow. On days 0-3, 4-10 and 11-18, PPFs were 100, 200, and 300 μmol/m²/s, respectively, in LL, LM, and LH; they were 200, 300, and 400 μmol/m²/s, respectively, in HL, HM, and HH.

In the photoautotrophic cultivation conditions, not only sugar was not added to the culture medium but also naphthaleneacetic acid (hereinafter, also referred to as “NAA”), which is one of plant growth regulators (plant hormones), vitamins and other organic substances were excluded from the modified MS medium. In photoautotrophic culture, Florialite (supporting S material made of vermiculite and cellulose fiber mixture with high porosity; Nisshinbo Industries, Inc.) was used as a supporting material. Ambient CO₂ concentration in the culture room was maintained at 1,500 μmol/mol using an infrared ray CO₂ controller. Gas-permeable films (diameter 10 mm, pore diameter of the membrane 0.5 μm) were attached on the hole on the lid and walls of the respective vessel to enhance the natural ventilation.

N, the number of air exchanges per hour of the culture vessel given in Table 1, was measured according to the method described by Kozai et al. (1986). In LM, LH, HM and HH treatments, N value was increased with passage of days by increasing the number of gas permeable film.

The CO₂ concentrations inside and outside the culture vessels were measured on days 3, 10 and 17 with a gas chromatograph (GC-12A, Shimadzu Co., Ltd., Kyoto, Japan).

The net photosynthesis rate was calculated according to the method developed by Fujiwara et al. (Fujiwara, K., Kozai, T., Watanabe, I., 1987, Measurements of carbon dioxide gas concentration in closed vessels containing tissue cultured plantlets and estimates of net photosynthetic rates of the plantelets, J. Agr. Meteorol. 43:21-30) using the following equation.

Pn=KNV(Cₒᵤₜ−Cᵢₙ)/E

where K is the conversion factor of CO₂ from volume to moles (0.0405 mol/l at 28° C.); N is the number of air exchanges of the culture vessel per hour (/h); V is the volume of the air portion of the culture vessel (0.37 L); Cᵢₙ and Cₒᵤₜ are CO₂ concentrations (μmol/mol) inside and outside the culture vessel under steady state conditions during irradiation period; E is the number of plantlets per vessel.

In the treatments under photoautotrophic cultivation conditions, the fresh and dry weights, leaf area and number of open (unfolded) leaves per plantlet were measured on days 0, 10 and 18. On day 18, some plantlets under photoautotrophic cultivation conditions have become significantly large in the culture vessel and top half of most leaves were touched with the inner surface of the culture vessel lid. Then, the experiment had to be finished on day 18.

<1-2> Control Treatment

On the other hand, in the treatment under the conventional photomixotrophic culture condition (control), sucrose (30 g/l) was added as a carbon energy source and naphthalene acetic acid (N t) (0.5 mg/i), which is a plant growth regulator (plant hormone), was added in order to promote rooting of the plantlets. Agar (5.5 g/l) is used as a supporting material for the root.

The CO₂ concentration in the culture room in the control treatments was made identical to the conventional CO₂ concentration in the atmospheric air (about 400 μmol/mol). In the control treatments, PPF was set to 60 μmol/m²/s throughout the experiment. The experiment period was 18 days for the treatments under photoautotrophic culture conditions in contrast to 30 days for the control treatment.

In the control treatment, the fresh and dry weight, leaf area and number of open (unfolded) leaves per plantlet were measured on days 0; 10, 18 and 30, respectively.

<2> Results

<2-1> Growth of Plantlets

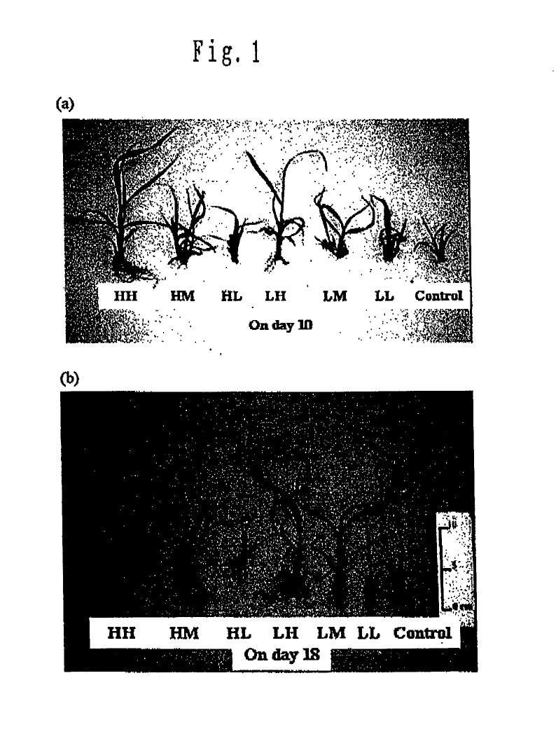

Results of growth and development on day 18 are summarized in Table 2 and FIG. 1.

TABLE 2

| Treatment | Leaf area | Fresh mass (mg) | | Dry mass (mg) | | Number of | Number of |
|---|---|---|---|---|---|---|---|
| Code | (mm²) | Shoot | Root | Shoot | Root | shoots | open leaves |
| Control | 319 ± 127d^{Z} | 303 ± 100c | 21 ± 15c | 29 ± 8cd | 2 ± 1c | 3.0 ± 1.0b | 4.3 ± 0.5d |
| LL | 190 ± 96d | 124 ± 86c | 33 ± 22c | 18 ± 8d | 5 ± 4c | 1.4 ± 0.5c | 3.4 ± 0.5d |
| LM | 700 ± 97c | 535 ± 101b | 311 ± 121bc | 77 ± 15bc | 24 ± 13bc | 3.6 ± 0.7ab | 5.9 ± 1.1c |
| LH | 1049 ± 317b | 716 ± 249b | 356 ± 114b | 107 ± 39b | 31 ± 11b | 3.8 ± 1.2ab | 5.3 ± 0.4c |
| HL | 135 ± 44d | 106 ± 29c | 46 ± 26c | 13 ± 5d | 4 ± 3c | 1.3 ± 0.4c | 4.3 ± 0.7d |
| HM | 1022 ± 400bc | 781 ± 329b | 388 ± 303b | 109 ± 47b | 34 ± 24b | 4.3 ± 1.6a | 7.4 ± 1.3b |
| HH | 1648 ± 65a | 1394 ± 616a | 669 ± 562a | 201 ± 104a | 61 ± 48a | 3.9 ± 1.3ab | 9.5 ± 1.9a |

Analysis of variance^{Y}

| | | | | | | | |
|---|---|---|---|---|---|---|---|
| No.^{A}(A) | **^{X} | ** | ** | ** | ** | ** | ** |
| PPF(B) | ** | ** | NS | * | NS | NS | ** |
| A × B | NS | * | NS | * | NS | NS | ** |

In Table 2, results of growth by the control treatments (conventional photomixotrophic cultivation) for comparison are also summarized (for treatment codes, see Table 1)

In Table 2, the number of shoots per plantlet represents the multiplication ratio (number of explants usable for the next multiplication stage). Also, in Table 2, “Z” represents that the same letters following the each mean value in the same column are not significantly different at p<0.05 by an LSD (least significant difference) tests “Y” indicates that analysis of variance was applied for 6 treatments which was combined with 2 levels of PPF and 3 levels of the number of air exchanges of the culture vessel. “X” shows that NS, * and ** indicate nonsignificant, significant at 5% level of probability (p=0.05) and significant at 1% level of probability (p=0.01), respectively. “A” indicates number of air exchanges of the culture vessel.

FIGS. 1(a) and 1(b) are photographs showing photoautotrophically grown sugarcane plantlets on days 10 (FIG. 1(a)) and 18 (FIG. 1(b)) as affected by PPF and the number of air exchanges of the culture vessel. Photomixotrophically grown plantlets in control treatments are also shown for comparison (for treatment codes, see Table 1).

The growth (leaf area, root and shoot fresh mass, and root and shoot dry mass) of sugarcane was the greatest in HH treatment among all the test lots. The leaf area, shoot and root fresh mass, and shoot and root dry mass per plantlet were, respectively, 5.2, 4.6, 32, 6.9 and 30 times greater in HH treatment than those in control treatment (the term “treatment” is omitted hereafter when appropriate).

The growth was significantly greater in HM, LH and LM than those in Control (Table 2, FIG. 1).

There were no significant difference in growth among LL, HL and Control.

Number of air exchanges of the culture vessel, N, affected all the growth parameters (leaf area, root and shoot fresh masses, and root and shoot dry masses) of sugarcane positively, PPF affected the leaf area, shoot fresh and dry masses positively.

The positive effects of N and PPF on the growth were already observed on day 10 (see Table 3). The growth was the greatest in HH among all the treatments.

TABLE 3

| | | | | Number of |
|---|---|---|---|---|
| | | | | open |
| | | | | leaves |
| Treatment | Leaf area | Fresh | Dry | (per |
| Code | (mm²) | mass (mg) | mass (mg) | plantlet) |
| Control | 298 ± 90c | 247 ± 111c | 20 ± 10c | 4.0 ± 0.7c |
| LL | 231 ± 152c | 201 ± 90c | 19 ± 12c | 4.0 ± 0.7c |
| LM | 431 ± 113b | 559 ± 151b | 57 ± 9b | 4.8 ± 0.8c |
| LH | 675 ± 144b | 651 ± 139b | 61 ± 15b | 7.5 ± 1.1b |
| HL | 265 ± 96c | 225 ± 72c | 21 ± 11c | 4.8 ± 0.8c |
| HM | 654 ± 161b | 634 ± 130b | 60 ± 13b | 5.0 ± 1.2c |
| HH | 1179 ± 221a | 1055 ± 258a | 33 ± 52a | 8.3 ± 1.1a |

Analysis of variance^{Y}

| | | | | |
|---|---|---|---|---|
| No.^{A}(A) | **^{X} | ** | ** | ** |
| PPF(B) | ** | ** | ** | NS |
| A × B | ** | ** | ** | NS |

Table 3 shows growth on day 10 under photoautotrophic culture condition using sugarcane plantlets as affected by PPF and the number of air exchanges of the culture vessel. Table 3 also shows results of growth in control treatment (conventional photomixotrophic culture) for comparison (for codes of treatments, see Table 1).

In Table 3, X indicates that NS and ** mean “nonsignificant” and “significant at 1% level of probability (P=0.01)”, respectively. Other symbols have the same meanings as in Table 2.

The leaf area, fresh and dry masses per sugarcane plantlet were, 4.0, 4.3 and 6.7 times, respectively, greater in HH than those in control treatment. The growth was significantly greater in EM, LH and LM than those in Control (Table 3). There were no significant differences in growth among LL, HL and Control. The growth and development of shoots and roots were already visibly observed from day 3 in HH and LH.

The root fresh and dry masses in HH were 32 and 30 times, respectively, greater than those in Control in which 0.5 mg/L of naphthaleneacetic acid (NAA), which is a plant growth regulator (plant hormone), was added (See Table 2). Enhanced rooting without NAA in HH was probably due to appropriate selection of the conditions of photoautotrophic culture and due to higher air porosity of the supporting material (i.e., Florialite). The supporting material with high air porosity generally gives a higher dissolved oxygen concentration around the shoot base than a gelling supporting material such as agar.

As stated above, growth of vigorous roots is essential for sugarcane plantlet survival during ex vitro acclimatization.

In the experiment, the growth of plantlets in HH, HM and LH was unexpectedly fast and not a few leaf tips of the plantlets reached the inside surface of the vessel lid on day 10.

On the other hand, the growth of plantlets was slow in Control, HL and LL.

Leaf area, fresh shoot and root mass, dry shoot and root mass and number of shoots per plantlet on day 30 in control were 423±83 mm², 439±75 mg, 36±5 mg, 3.6±0.5, respectively.

<2-2> CO₂ Concentration in the Culture Vessel

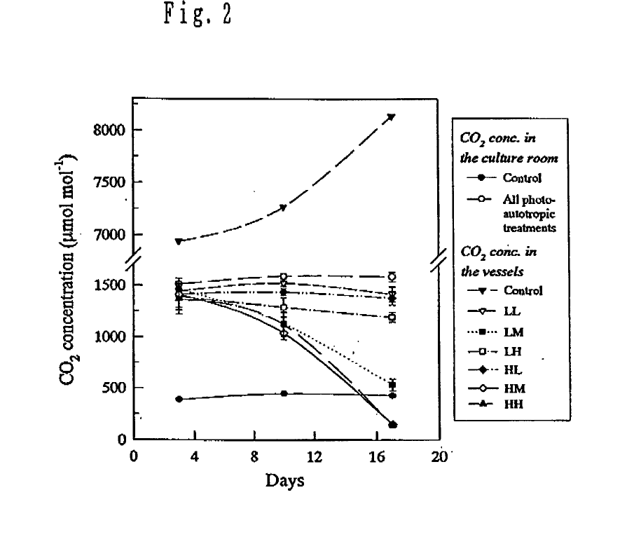

FIG. 2 is a diagram that illustrates variations with time of the CO₂ concentrations in the culture room and the culture vessel, respectively. It has been plotted with the values measured during the photoperiod. The CO₂ concentration in the culture vessel during the dark period of the photoautotrophic culture was at least 1,500 μmol/mol.

On the other hand, the CO₂ concentration in the culture vessel during the photoperiod of the photoautotrophic culture on day 3 was lower than that in the culture room (1,500 μmol/mol). This indicates that the net photosynthesis rate of the explants is positive from the beginning of the culture.

In HM and HH, the CO₂ concentration in the culture vessel during the photoperiod decreased with time and reached about 150 μmol/mol on day 17. The CO₂ concentration in LM on day 17 was 530 μmol/mol, of which value was about 1,000 μmol/mol lower than that in the culture room.

Under the photoautotrophic culture conditions, some plantlets in LL and HL gradually became yellowish and lost vigor during days 3 to 7. On day 12, 80 to 90% of the plantlets in LL and HL died and new shoots started emerging on days 14 and 15. This is probably due to the low CO₂ concentration in the culture vessel during the photoperiod as a result of a lower number of air exchanges of the culture vessel, giving the negative net photosynthesis rate of plantlets and thus the growth of plantlets in vitro was restricted. On the other hand, in HH, HM, LH and LM treatments, the number of air exchanges was higher than in LL and HL treatments and the leafs color remained green and vigorous.

The CO₂ concentration in LL and HL during the photoperiod did not decrease with culture time significantly.

The CO₂ concentration in Control was about 7,000, 7,300 and 8,100 μmol/mol on days 3, 10 and 17, respectively, compared with the CO₂ concentration in the culture room of 390 to 440 μmol/mol, indicating the negative net photosynthesis rate of explants/plantlets throughout the culture period.

<2-3> Net Photosynthesis Rate

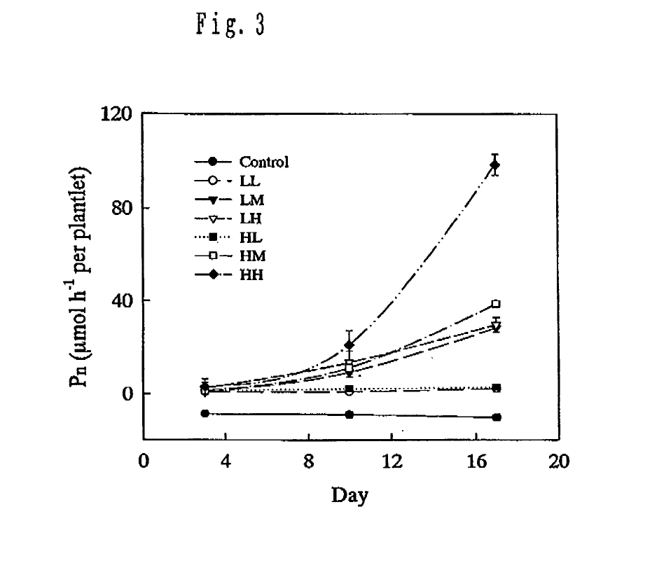

The net photosynthesis rate increased with culture time in HH, HM, LH and LM. It was the greatest in HH, which was 3.5, 16 and 95 μmol/h per plantlet on days 3, 10 and 17, respectively, followed by HM, LH and LM (FIG. 3).

The net photosynthesis rates in LL and HL were slightly positive throughout the experiment but did not increase with time.

An increase in number of air exchanges, N, increased the net photosynthesis rates of the plantlets significantly. The increase in N was due to enhancement of the air movement or air current speed around the plantlets in the culture vessel and promotion of the diffusion of CO₂ existing around the plantlets, resulting in the promotion of photosynthesis of in vitro plants. In addition, the increase in N decreases the relative humidity in the culture vessel during the photoperiod significantly, and, thus, increases transpiration rates of plantlets significantly.

Net photosynthesis rates were negative and the lowest in Control, which were −8.8, −9.2, and −10.4 μmol/h per plantlet on days 3, 10 and 17, respectively. The negative net photosynthesis rates in Control were probably due to the presence of sugar in the medium in the culture vessel, low PPF, and low number of air exchanges throughout the culture period (in the photoperiod, the CO₂ concentration in the culture vessel was low).

Increasing PPF and N (the number of air exchanges) with culture period as in HH, HM and LH under photoautotrophic conditions and keeping the CO₂ concentration in the culture vessel higher than that in the atmosphere have been very effective in promoting photosynthesis and thus growth.

<2-4> Number of Shoots and Open Leaves per Plantlet.

On day 18, the number of shoots, which were usable as explants for further multiplication in vitro and for transplant establishment ex vitro, was significantly higher in LM, LH, HM and HH than in HL, LL, and Control (Table 2). Thus, it can be said that the multiplication ratio was higher in LM, LH, HM and HH than in HL, LL and Control, enabling efficient production of plantlets.

Further, the number of unfolded leaves per plantlet on day 18 was significantly higher in HH than in the other treatments, and was lowest in Control, LL and UL (Table 2). The net photosynthesis rate of plantlets in vitro and of explants in ex vitro just after transplanting would be promoted in response to the number of unfolded leaves, or more precisely the leaf area, that the shoot (or explant) has. Thus, it can be said that explants in the HH treatment lot that had larger leaf area per plantlet than those in other treatment lots is a very favorable condition for photoautotrophic growth.

Relatively high multiplication ratio and large leaf area in HM and HH were probably due to the enhanced and simultaneous development and growth of root tissues and shoots, achieved by the high net photosynthesis rate of explants and the use of a porous supporting material. Faster growth of the root tissue improves absorption of water and nutrients, resulting in less wilting of the plantlets and better growth of shoots.

<2-5> Multiplication Cycle

As already shown in FIG. 1, the plantlets on day 18 in the HH treatment lot were overgrown and too large to be used for multiplication or acclimatization ex vitro. On the other hand, the plantlets on day 10 in HH were larger than those in Control on day 18 and were suitable in size for multiplication and for acclimatization ex vitro.

The number of unfolded leaves per plantlet on day 10 was 8.3 in HH, which is about 2 times greater than that on day 18 in Control.

It can be said, therefore, that optimal multiplication period in HH needs only about 10 days, which is one third of the period reguired for conventional tissue culture, namely 30 days. In other words, the multiplication rate can be remarkably increased in HH, compared with that in Control.

From the results of experiments described above, according to the present invention it can be seen that sugarcane plantlets cultured in vitro expressed high ability of photoautotrophic growth. In the photoautotrophic micropropagation, high PPF (100 to 500 μmol/m²/s), high CO₂ concentration and high number of air exchanges of the culture vessel (2 to 20/h) increased the growth of sugarcane plantlets significantly.

Use of porous supporting material in combination also enhanced the growth of sugarcane shoots and the root tissues. Furthermore, it was unnecessary to add any plant growth regulator (plant hormone) in the culture media.

The micropropagation of C₄ plants by photoautotrophic culture under the culture conditions described above in combination is a method that is more practical and superior in effect to the conventional micropropagation from the viewpoint of cost and culture periods due to the interactions among the conditions. In the photoautotrophic system with high PPF and high number of air exchanges of the culture vessel, the culture period of sugarcane plantlets in vitro is shortened by approximately 70% (from 30 days to 10 days) compared with the conventional micropropagation system. Therefore, the production costs can be expected to be reduced significantly. This will lead to increase in profit upon commercialization on a large scale.

What is claimed is:

1. A method of producing a plantlet of a C₄ plant, comprising:
transplanting a tissue of the C₄ plant into a culture medium free of sugar and containing a porous supporting material; and
culturing the tissue while supplying carbon dioxide under irradiation of light to form a plantlet of the plant.

2. A method according to claim 1, wherein the tissue of the C₄ plant is cultured in a culture vessel that allows passage of carbon dioxide to an outside of the vessel.

3. A method according to claim 2, wherein the culture vessel allows ventilation to the outside and wherein the concentration of carbon dioxide in the inside of the culture vessel is controlled by such way that the concentration of carbon dioxide is maintained higher in atmosphere around the culture vessel than in the inside of the culture vessel.

4. A method according to claim 3, wherein the tissue of the C₄ plant is cultured while ventilation is performed at a number of air exchanges of 2 to 20/h.

5. A method according to claim 3, wherein the tissue of the C₄ plant is cultured at a concentration of carbon dioxide in the atmosphere around the culture vessel of 1,000 to 2,000 μmol/mol.

6. A method according to claim 3, wherein the tissue of the C₄ plant is cultured at a concentration of carbon dioxide in the inside of the culture vessel of 400 to 2,000 μmol/mol.

7. A method according to claim 5, wherein the tissue of the C₄ plant is cultured at a concentration of carbon dioxide in the inside of the culture vessel of 400 to 2,000 μmol/mol.

8. A method according to claim 2, wherein the culture vessel is provided with means for intaking and venting air to supply carbon dioxide into the vessel.

9. A method according to claim 8, wherein the tissue of the C₄ plant is cultured with ventilation through the means for intaking and venting air at a number of air exchanges of 2 to 20/h.

10. A method according to claim 8, wherein the tissue of the C₄ plant is cultured at a concentration of carbon dioxide in the atmosphere around the culture vessel of 1,000 to 2,000 μmol/mol.

11. A method according to claim 8, wherein the tissue of the C₄ plant is cultured at a concentration of carbon dioxide in the inside of the culture vessel of 400 to 2,000 μmol/mol.

12. A method according to claim 10, wherein the tissue of the C₄ plant is cultured at a concentration of carbon dioxide in the inside of the culture vessel of 400 to 2,000 μmol/mol.

13. A method according to claim 1, wherein the tissue of the C₄ plant is cultured under light irradiation at a photosynthetic photon flux of 100 to 500 μmol/m²/s.

14. A method according to claim 1, wherein the porous supporting material is at least one member selected from the group consisting of vermiculite, pearlite, cellulose fiber, cellulose derivative fiber, polyester fiber, ceramic fiber, rock wool, and mixtures thereof.

15. A method according to claim 14, wherein the porous supporting material comprises a mixture of cellulose fiber and vermiculite.

16. A method according to claim 1, wherein the medium comprises a culture solution free of plant growth regulators.

17. A method according to claim 1, wherein the C₄ plant is sugarcane.
